(19) United States
(12) Patent Application Publication
(10) Pub. No.: US 2017/0213043 A1
(43) Pub. Date: Jul. 27, 2017

(54) SECURITY HARDENED CONTROLLER AREA NETWORK TRANSCEIVER

(71) Applicant: Mentor Graphics Corporation, Wilsonville, OR (US)

(72) Inventors: Antal Rajnak, Cologny (CH); Rainer Oder, Villingen-Schwenningen (DE)

(21) Appl. No.: 15/008,127

(22) Filed: Jan. 27, 2016

(51) Int. Cl. G06F 21/60; G06F 21/62

(52) U.S. Cl. CPC G06F 21/606; G06F 21/6218

(57) ABSTRACT

This application discloses a controller area network node including a controller and a transceiver. The transceiver includes security circuitry to perform various security checks on messages the controller area network node intends to have transmitted over a shared bus in a controller area network. The security circuitry can determine whether the messages conform to the rules associated with a design and a traffic scheduling of the controller area network. Some of those rules include that the controller area network node transmit messages with identifiers that were assigned to the controller area network node, or transmit messages with a specified timing. When the security circuitry identifies one of the messages fails to conform to the rules for the controller area network, the security circuitry can initiate a security action, such as refusing or delaying transmission of the messages or reporting the rules violation to the controller.

### TECHNICAL FIELD

This application is generally related to network communication and, more specifically, to combatting vulnerabilities in a controller area network (CAN).

### BACKGROUND

A controller area network (CAN) standard defines a message-based protocol that can be utilized to transmit and receive messages between multiple controllers over a shared bus. This technology is widely utilized in the automotive and aerospace industries to transmit messages through vehicles and airplanes, for example, communicating sensory input or device states between various controllers over the bus.

Controllers with messages to send can arbitrate for bus access based on an identification field (ID) in the messages, as a value in the identification field can both identify the message and indicate the priority of the message. When controllers have messages to transmit on the bus, each of them can begin transmitting their corresponding message on the bus during a same transmission period and listen to the bus to determine whether the identification field of their message was overwritten by a message from a competing controller. If the identification field of their message was not overwritten, the controller has control over the bus and can continue to transmit the message. When the identification field of their message is overwritten, however, the controller loses bus arbitration to another controller with a dominant priority annunciated by the identification field in the message.

Since the controller area network standard does not include any mechanism in its message-based protocol to authenticate a source of a message transmitted over the bus, from the security point of view, this represents a significant weakness against masquerading, or re-play attacks. For example, an attacker can compromise a controller and direct it to inject malicious messages onto the bus that would be indistinguishable from valid messages by receiving controllers.

The controller area network standard further does not include any protection against controllers exceeding prescribed limits on messaging frequency, or from Denial of Service (DoS) type of attacks. For example, a compromised or malfunctioning controller can flood the bus with a stream of legal or illegal messages without any mechanism to halt the over-consumption of bus bandwidth.

### SUMMARY

This application discloses a controller area network node including a controller and a transceiver. The transceiver includes security circuitry to perform various security checks on messages the controller area network node intends to have transmitted over a shared bus in a controller area network. The security circuitry can determine whether the messages conform to the rules established by the design of the specific network. Some of those rules include that the controller area network node transmit messages with identifiers that were assigned to the controller area network node, or transmit messages with a specified timing constraints. When the security circuitry identifies one of the messages fails to conform to the rules associated with transmissions on the controller area network, the security circuitry can initiate a security action, such as refusing or delaying transmission of the messages or reporting the rules violation to the controller. Embodiments will be described below in greater detail.

### DESCRIPTION OF THE DRAWINGS

FIG. 1 illustrates an example controller area network according to various embodiments of the invention.

FIG. 2 illustrates an example security transceiver according to various embodiments of the invention.

FIG. 3 illustrates a flowchart showing a self-learning mode for a security transceiver according to various examples of the invention.

FIG. 4 illustrates a flowchart showing a transmission security mode for a security transceiver according to various examples of the invention.

FIG. 5 illustrates a flowchart showing a masquerading security mode for a security transceiver according to various examples of the invention.

FIGS. 6 and 7 illustrate an example of a computer system of the type that may be used to implement various embodiments of the invention.

### DETAILED DESCRIPTION

### Illustrative Controller Area Network (CAN)

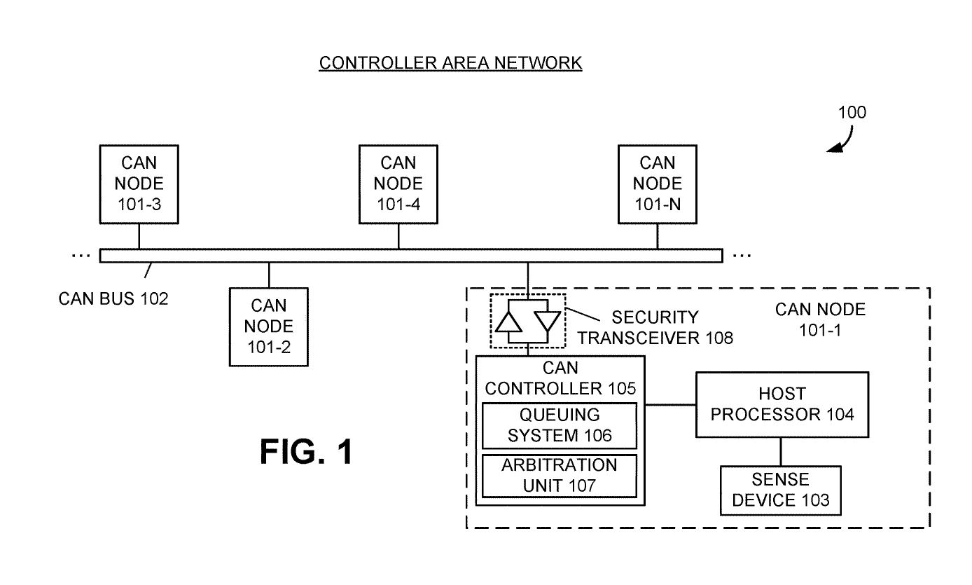

FIG. 1 illustrates an example controller area network 100 according to various embodiments of the invention. Referring to FIG. 1, a controller area network 100 can include multiple CAN nodes 101-1 to 101-N coupled to exchange messages over a CAN bus 102 in a serial-fashion according to a message-based protocol, for example, as defined by a controller area network standard. Since the CAN bus 102 is a shared system resource, the CAN nodes 101-1 to 101-N can arbitrate for access to the CAN bus 102 with their corresponding messages. In some embodiments, the messages can include identification fields or identifiers, which can provide an identification of the message as well as indicate a priority of the message. For example, when the CAN node 101-1 has a message to transmit over the CAN bus 102, the CAN node 101-1 can begin transmitting the identification field of the message on the CAN bus 102 and listen to the CAN bus 102 to determine using bit-wise arbitration whether a recessive bit in the own message ID was overwritten by a dominant bit transmitted by a different node, indicating another one of the CAN nodes 101-2 to 101-N transmitted a different message on the CAN bus 102 having a higher priority level. If the identification field of the message was not overwritten, the CAN node 101-1 has control over the CAN bus 102 and can continue to transmit the message body containing the payload. When the identification field of the message was overwritten, however, the CAN node 101-1 lost bus arbitration to the message having an identification field with the higher priority level.

The CAN node 101-1 can include a host processor 104 to generate messages for transmission over the CAN bus 102, for example, in response to input from a sense device 103. The sense device 103 can be a sensor, an actuator feedback signal, or other control device internal or external to the CAN node 101-1, which can generate the input for the CAN node 101-1 based on external conditions or activities. For example, the sense device 103 can be a sensor, such as a tire pressure sensor, temperature sensor, or any other type of sensor, which can generate input based on a sensed external condition. When the sense device 103 is a button, a switch, a multi-state device, or the like, the sense device 103 can generate input based on a current state or in response to a change of a state.

The CAN node 101-1 can include a CAN controller 105 to receive the messages generated by the host processor 104 and present the messages to the CAN bus 102 for transmission via a security transceiver 108. The CAN controller 105 can receive messages from other CAN nodes 102-2 to 102-N over the CAN bus 102 via the security transceiver 108, and forward the messages to the host processor 104 for processing. The security transceiver 108 also can include security circuitry to ascertain whether messages to be transmitted or having been received via the CAN bus 102 violate various rules corresponding to conforming communication over the CAN bus 102. Embodiments of the security transceiver 108 will be described below in greater detail.

The CAN controller 105 can include a queuing system 106 to order messages awaiting transmission over the CAN bus 102. The queuing system 106 can order these messages with any number of schemes, for example, the ordering can be based on message priority in an identification field, arrival time of the messages at the CAN controller 105, a combination of thereof, or the like. For example, the queuing system 106 in the CAN controller 105 can be implemented as one or more queues or buffers capable of ordering messages without priority inversion, implemented as a queuing system that can allow message priority inversion, such as a First-In-First-Out (FIFO) buffer, a paired buffering system, or the like.

The CAN controller 105 can include an arbitration unit 107 to determine when the CAN node 101-1 gains access to the CAN bus 102 to transmit a particular message. For example, when transmitting the identification field of a message, the arbitration unit 107 can listen to the bus to identify whether the identification field of the message was overwritten on the CAN bus 102 and prompt the CAN controller 105 to continue or cease transmitting the message based on whether the identification field of the message was overwritten on the CAN bus 102. Each CAN node 101-2 to 101-N can include electrical components similar to those of the CAN node 101-1 shown in FIG. 1—the specific instances of those electrical components, however, can be implemented variously in the controller area network 100.

### Example Security Transceiver

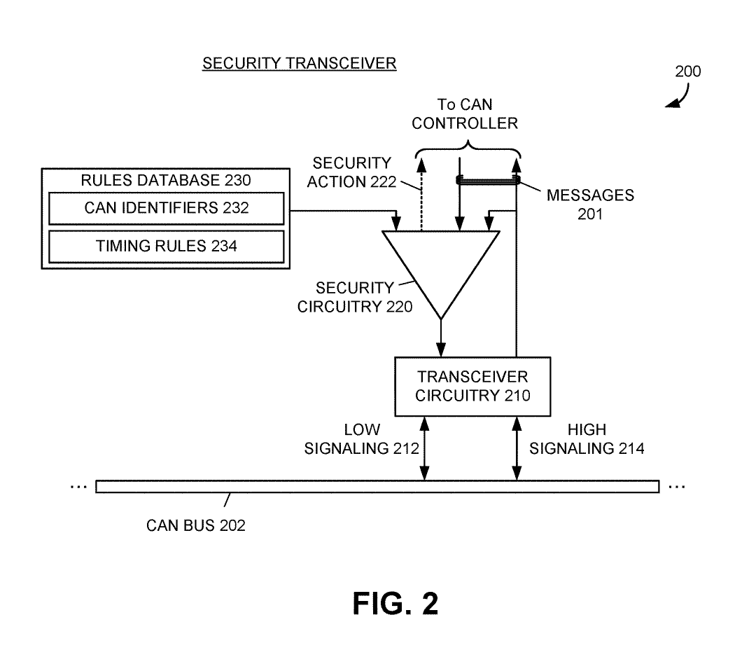

FIG. 2 illustrates an example security transceiver 200 according to various embodiments of the invention. Referring to FIG. 2, the security transceiver 200 can include transceiver circuitry 210 to transmit and receive the messages 201 on a CAN bus 202. In some embodiments, the transceiver circuitry 210 can interact with the CAN bus 202 via low signaling 212 and high signaling 214, which can annunciate values of bits in the messages 201 exchanged over the CAN bus 202.

The security transceiver 200 can include security circuitry 220 to analyze messages 201 to be transmitted on the CAN bus 202 to determine whether they conform to rules associated with transmissions on the CAN bus 202. For example, the security circuitry 220 can determine whether the messages 201 to be transmitted from a CAN node utilize an identifier assigned to that CAN node. The security circuitry 220 also can determine whether transmission of the messages 201 from the CAN node would comply with message timing rules under the controller area network standard. In some embodiments, the security circuitry 220 also can analyze messages 202 received by the transceiver circuitry 210 from the CAN bus 202.

The security circuitry 220 can extract an identifier or identification field from each of the messages 201 and then utilize a rules database 230 to determine whether any of the messages 201 pose a security risk or violate any rules established by the design of the specific network. In some embodiments, in response to identifying a security risk or a rule violation, the security circuitry 220 can initiate a security action 222, such as prompting destruction of a message on the CAN bus 202, refusing or delaying presentation of a message on the CAN bus 202 for transmission, reporting the security risk or the rule violation to a CAN controller in the CAN node having the security transceiver, or the like.

The rules database 230, in some embodiments, can include a list of one or more CAN identifiers 232 corresponding to identifiers assigned to the CAN node that includes the security transceiver 200. The rules database 230 can be populated with the list of the CAN identifiers 232 in a variety of ways, including automatically during operation of the security transceiver 200, or pre-populated prior to implementation in the controller area network. As will be described below in greater detail, the security circuitry 220 can perform the self-learning mode, which can detect identifiers in the messages 201 transmitted by the security transceiver 200 and populate the CAN identifiers 232 portion of the rules database 230 with the detected identifiers.

The rules database 230, in some embodiments, can include timing rules 234 for the messages 201. Since the controller area network standard can limit how often different messages can be transmitted on the CAN bus, the timing rules 234 can correspond to rules for frequency of transmission of the messages 201 imposed by the actual design and traffic scheduling of the specific network. The security circuitry 220 also can store timestamps corresponding to times for the most recently transmitted message having each identifier and associate the timestamps to corresponding timing rules 234 in the rules database 230.

The security circuitry 200 can have multiple different modes of operation, such as a self-learning mode, a transmission security mode, and masquerading security mode. Each of these operational modes will be described below in greater detail. The rules database 230 can include information capable of configuring the security circuitry 220 into one or more of the operational modes. For example, when the security circuitry 220 is implemented as a processing device, such as a co-processor, the security circuitry 220 can execute instructions stored in the rules database 230 that can prompt the security circuitry 220 to implement one or more of its operational modes. In other embodiments, the security circuitry 220 can be implemented as specialized hardware, for example, which can have one or more registers capable of storing one or more configuration bits from the rules database 230. The security circuitry 220 can implement one or more of its operational modes based on the one or more configuration bits stored in the registers.

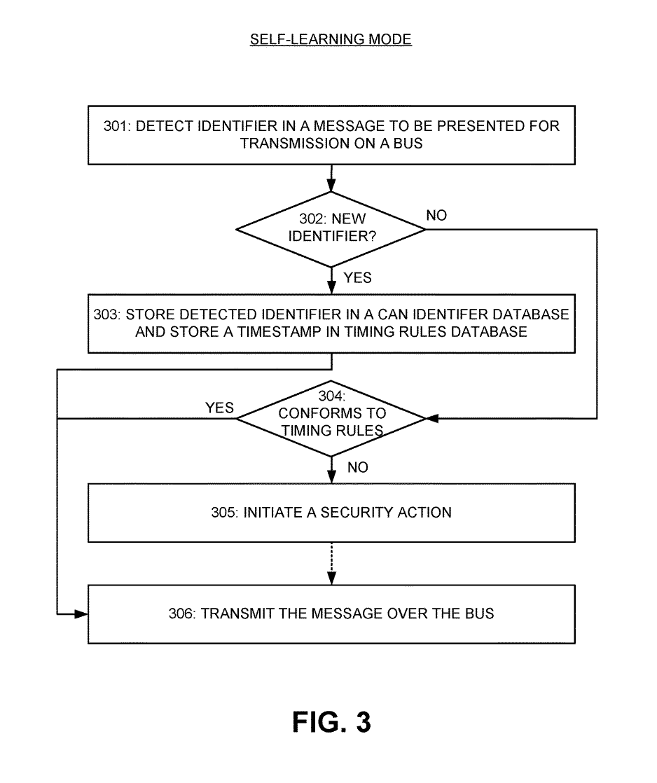

FIG. 3 illustrates a flowchart showing a self-learning mode for a security transceiver according to various examples of the invention. Referring to FIG. 3, in a block 301, a security transceiver can detect an identifier in a message stream to be presented for transmission on a bus. In some embodiments, the security transceiver can receive the message from a CAN controller in a CAN node that includes the security transceiver.

In a block 302, the security transceiver can determine whether the detected identifier is new to the security transceiver. In some embodiments, the security transceiver can compare the detected identifier to a list of identifiers assigned to the CAN node. When the detected identifier is included in the list of identifiers, the security circuitry can determine that the detected identifier is not new to the security transceiver. Conversely, when the detected identifier is not included in the list of identifiers, the security circuitry can determine that he detected identifier is new to the security transceiver.

When the detected identifier is new to the security transceiver, in a block 303, the security transceiver can store the detected identifier in a CAN identifier database and store a timestamp corresponding to the message in timing rules database. For example, the security transceiver can add the detected identifier to the list of identifiers, which can be stored in the CAN identifier database accessible by the security transceiver. In some embodiments, the timing rules database can store timing information corresponding to messages capable of transmission on a CAN bus. In the block 303, the security transceiver can store the time stamp associated with a transmission of the message on the CAN bus in the rules database, which can update the timing information. After execution of block 303, execution can proceed to a block 306, where the security transceiver can transmit the message over the bus. In some embodiments, the security transceiver can utilize transceiver circuitry to present the message on the CAN bus for distributed bus arbitration and ultimately transmission on the CAN bus.

When, in the block 302, the detected identifier is determined to not be new to the security transceiver, in a block 304, the security transceiver can determine whether the message conforms to timing rules. In some embodiments, the security transceiver can determine a time that has elapsed since the last transmission of a message having the same identifier as the detected identifier in the instant message, and then compare the elapsed time against the timing rules. The timing rules may specify minimum or expected time periods between transmissions of different types of messages. For example, certain messages can be sporadically transmitted by a CAN node, and thus the timing rules can specify a minimum time period required between transmissions of those sporadic messages. In some examples, the messages can be periodically transmitted, and the timing rules can specify a time period associated with the periodicity of those messages.

When the message does conform to the timing rules, execution can proceed to the block 306, where the security transceiver can transmit the message over the bus. When the message does not conform to the timing rules, in a block 305, the security transceiver can initiate a security action. In some embodiments, the security action can include refusing or delaying presentation of the message on the CAN bus for transmission, reporting a security risk or a rule violation to a CAN controller in the CAN node having the security transceiver, or the like. In some embodiments, the initiation of the security action can end the flow, or optionally execution can proceed to the block 306, where the security transceiver can transmit the message over the bus.

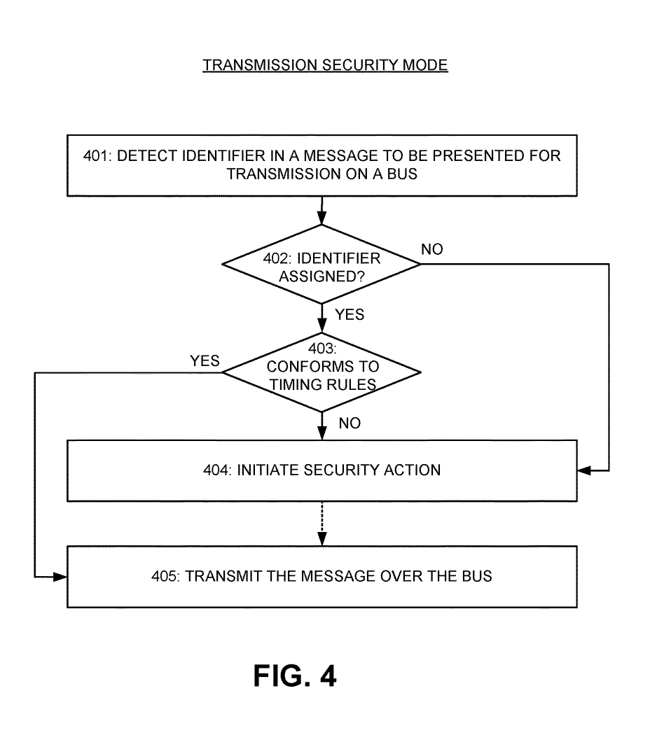

FIG. 4 illustrates a flowchart showing a transmission security mode for a security transceiver according to various examples of the invention. Referring to FIG. 4, in a block 401, a security transceiver can detect an identifier in a message to be presented for transmission on a bus. In some embodiments, the security transceiver can receive the message from a CAN controller in a CAN node that includes the security transceiver.

In a block 402, the security transceiver can determine whether the detected identifier has been assigned for a controller area network node. In some embodiments, the security transceiver can compare the detected identifier to a list of identifiers assigned to the CAN node. When the detected identifier is included in the list of identifiers, the security circuitry can deem the detected identifier as having been assigned for the controller area network node. In some embodiments, the list of identifiers can be those identifiers that the CAN node can utilize when transmitting a message on the bus. When the detected identifier is not present in the list of identifiers, a controller or host processor of the CAN node may be compromised, for example, by an attacker, or the CAN node can be malfunctioning.

When the detected identifier has not been assigned for the CAN node, in a block 404, the security transceiver can initiate a security action. In some embodiments, the security action can include refusing or delaying presentation of the message on the bus for transmission, reporting the identifier discrepancy to the CAN controller in the CAN node that includes the security transceiver, or the like. In some embodiments, the initiation of the security action can end the flow, or optionally execution can proceed to a block 405, where the security transceiver can transmit the message over the bus.

When the detected identifier has been assigned for the CAN node, in a block 403, the security transceiver can determine whether the message conforms to timing rules associated with the detected identifier. In some embodiments, the security transceiver can determine a time that has elapsed since the last transmission of a message having the detected identifier, and then compare the elapsed time against the timing rules. The timing rules may specify minimum or expected time periods between transmissions of different types of messages. For example, certain messages can be sporadically transmitted by the controller area network node, and thus the timing rules can specify a minimum time period required between transmissions of those sporadic messages. In some examples, the messages can be periodically transmitted, and the timing rules can specify a time period associated with the periodicity of those messages.

When the message does not conform to timing rules associated with the detected identifier, in the block 404, the security transceiver can initiate the security action. When the message conforms to the timing rules associated with the detected identifier, in the block 405, the security transceiver can transmit the message over the bus.

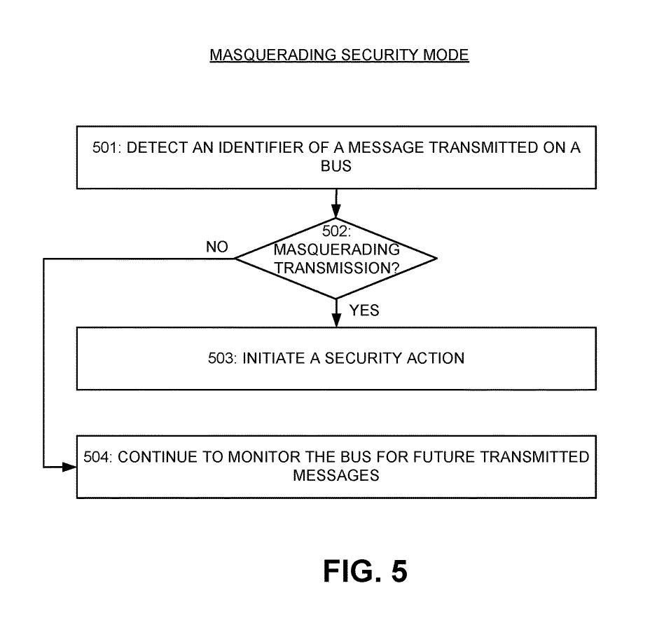

FIG. 5 illustrates a flowchart showing a masquerading security mode for a security transceiver according to various examples of the invention. Referring to FIG. 5, in a block 501, a security transceiver can detect an identifier in a message transmitted on a CAN bus. The security transceiver can be included in a CAN node having a CAN controller. In some embodiments, the security transceiver can include transceiver circuitry to monitor the CAN bus for messages transmitted by other CAN nodes. The transceiver circuitry can pass the monitored messages to both the CAN controller in the CAN node and to security circuitry in the security transceiver.

In a block 502, the security transceiver can determine whether the message is a masquerading transmission based on the detected identifier. In some embodiments, the security circuitry in the security transceiver can compare the detected identifier to a list of identifiers assigned to the CAN node that includes the security transceiver. This list of identifiers, in some examples, can be populated based on the self-learning technique described above with reference to FIG. 3.

When the detected identifier is included in the list of identifiers, the security circuitry can deem the message a masquerading message. In some embodiments, the list of identifiers can be those identifiers assigned to the CAN node. When the detected identifier is present in the list of identifiers, another CAN node has transmitted a message with an identifier not assigned to it, making the message an illegal message. The other CAN node may have transmitted an illegal message due to being compromised by an attacker or due to a malfunction.

When the message is a masquerading transmission, in a block 503, the security transceiver can initiate a security action. In some embodiments, the security action can include at least one prompting destruction of a message on the bus, for example, by forcing at least six dominant bits on the bus during the transmission of the message, reporting the masquerading transmission to the CAN controller in the CAN node having the security transceiver, or the like. When the message is not a masquerading transmission, in a block 504, the security transceiver can continue to monitor the bus for future transmitted messages.

### Illustrative Operating Environment

The controller area network nodes can include components, such as the security transceiver, CAN controller, or host processor, which can implement controller area network security processes according to embodiments of the invention, which may be implemented using computer-executable software instructions executed by one or more programmable computing devices. Because these embodiments of the invention may be implemented using software instructions, the components and operation of a programmable computer system on which various embodiments of the invention may be employed will first be described. Various controller area network security processes can be configured to operate on a computing system capable of simultaneously running multiple processing threads.

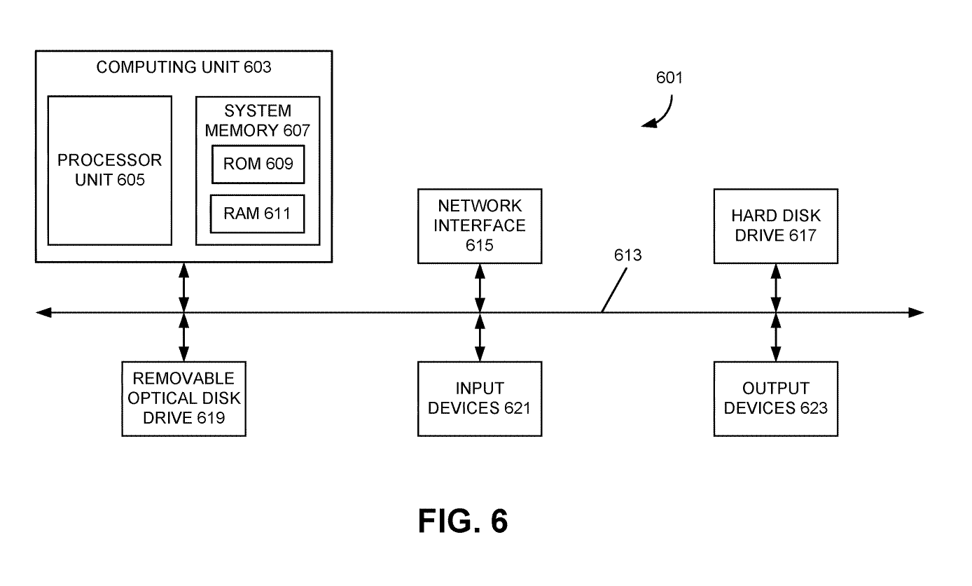

Various examples of the invention may be implemented through the execution of software instructions by a computing device 601, such as a programmable computer. Accordingly, FIG. 6 shows an illustrative example of a computing device 601. As seen in this figure, the computing device 601 includes a computing unit 603 with a processing unit 605 and a system memory 607. The processing unit 605 may be any type of programmable electronic device for executing software instructions, but will conventionally be a microprocessor. The system memory 607 may include both a read-only memory (ROM) 609 and a random access memory (RAM) 611. As will be appreciated by those of ordinary skill in the art, both the read-only memory (ROM) 609 and the random access memory (RAM) 611 may store software instructions for execution by the processing unit 605.

The processing unit 605 and the system memory 607 are connected, either directly or indirectly, through a bus 613 or alternate communication structure, to one or more peripheral devices 617-623. For example, the processing unit 605 or the system memory 607 may be directly or indirectly connected to one or more additional memory storage devices, such as a hard disk drive 617, which can be magnetic and/or removable, a removable optical disk drive 619, and/or a flash memory card. The processing unit 605 and the system memory 607 also may be directly or indirectly connected to one or more input devices 621 and one or more output devices 623. The input devices 621 may include, for example, a keyboard, a pointing device (such as a mouse, touchpad, stylus, trackball, or joystick), a scanner, a camera, and a microphone. The output devices 623 may include, for example, a monitor display, a printer and speakers. With various examples of the computing device 601, one or more of the peripheral devices 617-623 may be internally housed with the computing unit 603. Alternately, one or more of the peripheral devices 617-623 may be external to the housing for the computing unit 603 and connected to the bus 613 through, for example, a Universal Serial Bus (USB) connection.

With some implementations, the computing unit 603 may be directly or indirectly connected to a network interface 615 for communicating with other devices making up a network. The network interface 615 can translate data and control signals from the computing unit 603 into network messages according to one or more communication protocols, such as the transmission control protocol (TCP) and the Internet protocol (IP). Also, the network interface 615 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 601 is illustrated as an example only, and it not intended to be limiting. Various embodiments of the invention may be implemented using one or more computing devices that include the components of the computing device 601 illustrated in FIG. 6, which include only a subset of the components illustrated in FIG. 6, or which include an alternate combination of components, including components that are not shown in FIG. 6. For example, various embodiments of the invention may be implemented using a multi-processor computer, a plurality of single and/or multiprocessor computers arranged into a network, or some combination of both.

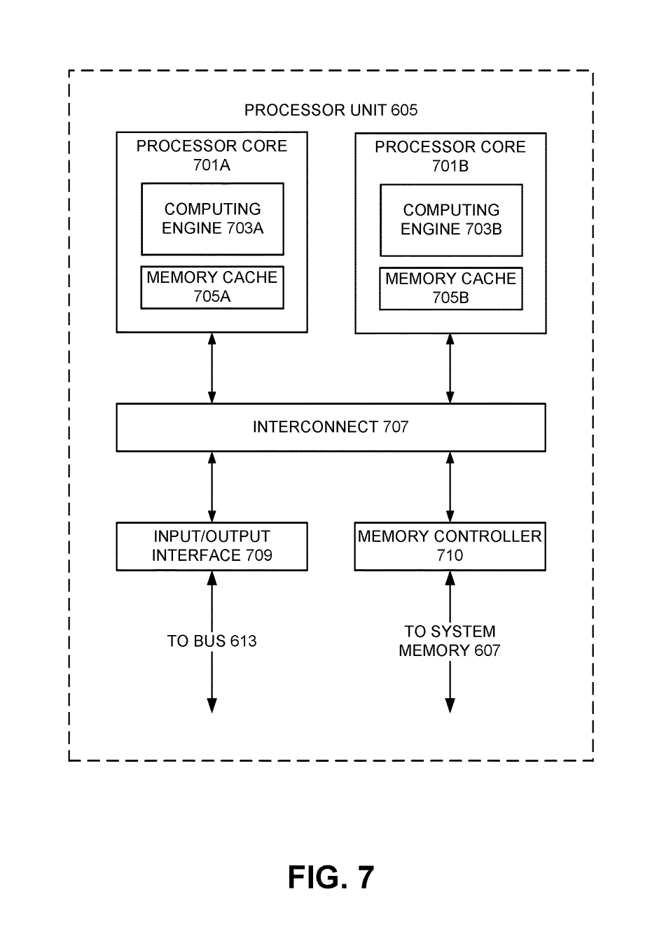

With some implementations of the invention, the processor unit 605 can have more than one processor core. Accordingly, FIG. 7 illustrates an example of a multi-core processor unit 605 that may be employed with various embodiments of the invention. As seen in this figure, the processor unit 605 includes a plurality of processor cores 701A and 701B. Each processor core 701A and 701B includes a computing engine 703A and 703B, respectively, and a memory cache 705A and 705B, respectively. As known to those of ordinary skill in the art, a computing engine 703A and 703B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 703A and 703B may then use its corresponding memory cache 705A and 705B, respectively, to quickly store and retrieve data and/or instructions for execution.

Each processor core 701A and 701B is connected to an interconnect 707. The particular construction of the interconnect 707 may vary depending upon the architecture of the processor unit 605. With some processor cores 701A and 701B, such as the Cell microprocessor created by Sony Corporation, Toshiba Corporation and IBM Corporation, the interconnect 707 may be implemented as an interconnect bus. With other processor units 701A and 701B, however, such as the Opteron™ and Athlon™ dual-core processors available from Advanced Micro Devices of Sunnyvale, Calif., the interconnect 707 may be implemented as a system request interface device. In any case, the processor cores 701A and 701B communicate through the interconnect 707 with an input/output interface 709 and a memory controller 710. The input/output interface 709 provides a communication interface to the bus 613. Similarly, the memory controller 710 controls the exchange of information to the system memory 607. With some implementations of the invention, the processor unit 605 may include additional components, such as a high-level cache memory accessible shared by the processor cores 701A and 701B. It also should be appreciated that the description of the computer network illustrated in FIG. 6 and FIG. 7 is provided as an example only, and it not intended to suggest any limitation as to the scope of use or functionality of alternate embodiments of the invention.

The system and apparatus described above may use dedicated processor systems, micro controllers, programmable logic devices, microprocessors, Graphical Processing Units, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, a GPU, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, serial FLASH, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to controller area networks, it should be appreciated that various examples of the invention may be implemented using any desired combination of electronic design automation processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
receiving, by a security transceiver, a message to transmit onto a shared bus in a controller area network (CAN);
utilizing, by the security transceiver, an identifier in the message to determine whether the message conforms to rules associated with a design and a traffic scheduling of the controller area network; and
initiating, by the security transceiver, a security action in response to the message failing to conform to the rules associated with the design and the traffic scheduling of the controller area network.

2. The method of claim 1, further comprising transmitting, by the security transceiver, the message onto the shared bus in the controller area network when the message conforms to the rules associated with the design and the traffic scheduling of the specific network.

3. The method of claim 1, wherein utilizing the identifier in the message further comprises comparing the identifier to a list of identifiers assigned to a CAN node including the security transceiver.

4. The method of claim 3, wherein initiating the security action is performed when the identifier in the message is not present in the list of identifiers assigned to the CAN node.

5. The method of claim 3, wherein utilizing the identifier in the message further comprises, when the identifier in the message is present in the list of identifiers assigned to the CAN node, comparing the message to timing rules associated with the identifier, and wherein initiating the security action is performed when the message fails to conform with the timing rules.

6. The method of claim 1, wherein the security action includes at least one of refusing to transmit the message of on the shared bus in the controller area network, delaying transmission of the message of on the shared bus in the controller area, reporting a security risk or rules violation to a controller in a CAN node that includes the security transceiver.

7. The method of claim 1, wherein the controller and the security transceiver are included in a CAN node of the controller area network.

8. A method comprising:
detecting, by a security transceiver in a controller area network (CAN) node, identifiers in messages to be transmitted onto a shared bus in a controller area network;
populating, by the security transceiver, a list of identifiers assigned to the CAN node to include the detected identifiers;
monitoring, by the security transceiver, a shared bus in the controller area network to detect a message transmitted on the shared bus;
comparing, by the security transceiver, an identifier in the detected message to the list of identifiers assigned to the CAN node; and
initiating, by the security transceiver, a security action when the identifier in the detected message is included on the list of identifiers.

9. The method of claim 8, wherein populating the list of identifiers assigned to the CAN node to include the detected identifiers further comprises:
determining whether the list of identifiers includes each of the detected identifiers; and
modifying the list of identifiers to include those detected identifiers not included in the list of identifiers.

10. The method of claim 8, further comprising storing, by the security transceiver, timestamps corresponding to the messages to be transmitted onto the shared bus.

11. The method of claim 10, further comprising:
utilizing, by the security transceiver, the stored timestamps to determine whether the messages to be transmitted onto the shared bus timing rules for the controller area network; and
initiating, by the security transceiver, the security action when the message fails to conform with the timing rules.

12. The method of claim 11, wherein the timing rules are configured to specify timing constraints for transmissions of different types of the messages.

13. The method of claim 8, wherein the security action includes at least one of refusing to transmit the message of on the shared bus in the controller area network, delaying transmission of the message of on the shared bus in the controller area, reporting a security risk or rules violation to a controller in a CAN node that includes the security transceiver.

14. An apparatus comprising:
a controller area network (CAN) controller configured to output a message for transmission onto a shared bus in a controller area network; and
security transceiver configured to utilize an identifier in the message to determine whether the message conforms to rules associated with a design and a traffic scheduling of the controller area network, and initiate a security action in response to the message failing to conform to the rules associated with the design and the traffic scheduling of the controller area network.

15. The apparatus of claim 14, wherein the security transceiver is configured to transmit the message onto the shared bus in the controller area network when the message conforms to the rules associated with the design and the traffic scheduling of the controller area network.

16. The apparatus of claim 14, wherein the security transceiver is configured to compare the identifier to a list of identifiers assigned to a CAN node including the security transceiver.

17. The apparatus of claim 16, wherein the security transceiver is configured to initiate the security action when the identifier in the message is not present in the list of identifiers assigned to the CAN node.

18. The apparatus of claim 16, wherein the security transceiver is configured to compare the message to timing rules associated with the identifier when the identifier in the message is present in the list of identifiers assigned to the CAN node, and configured to initiate the security action is performed when the message fails to conform with the timing rules.

19. The apparatus of claim 18, wherein the timing rules are configured to specify time periods between transmissions of different types of the messages.

20. The apparatus of claim 14, wherein the security action includes at least one of refusing to transmit the message of on the shared bus in the controller area network, delaying transmission of the message of on the shared bus in the controller area network, reporting a security risk or a rule violation to the CAN controller.
